(19) United States
(12) Patent Application Publication
(10) Pub. No.: US 2025/0211327 A1
(43) Pub. Date: Jun. 26, 2025

(54) MEDIUM RANGE SPEECH COMMUNICATION SYSTEMS, METHODS, AND DEVICES

(71) Applicant: ioAire, Inc., Eagle, ID (US)

(72) Inventor: Thomas P. Jensen, Eagle, ID (US)

(21) Appl. No.: 18/390,841

(22) Filed: Dec. 20, 2023

(51) Int. Cl. H04B 7/26; G06F 3/16; G06F 16/33; G06F 16/332; G06F 16/338; G06Q 10/087

(52) U.S. Cl. CPC H04B 7/26; G06F 3/167; G06F 16/3329; G06F 16/334; G06F 16/338; G06Q 10/087

(57) ABSTRACT

Systems, methods, and devices for providing medium range communication between portable devices are provided herein. One method includes receiving a query from a portable device within a medium range communication area of a medium range connection device; determining whether the query is in speech format; determining whether the query is a computing device readable text format; determining an action to take with the computing device and taking the determined action that produces a result of the query; and returning the result of the action to the portable device from which the query was received.

### TECHNICAL FIELD

The present disclosure relates to medium range speech communication systems, methods, and devices.

### BACKGROUND

Facilities can include complexes such as warehouses, medical centers, universities, and the like. Typically, such facilities are large and can be complex (e.g., large building, multiple floors, facilities with multiple buildings) and as such, communication can be difficult between user devices. Typically, the means of communication are cellular networks for use with mobile devices and Wi-Fi networks for use primarily for computer to computer communication.

### BRIEF DESCRIPTION OF THE DRAWINGS

FIG. 1 is a medium range speech communication system at a facility in accordance with one or more embodiments of the present disclosure.

FIG. 2 is a computing device for medium range speech communication in accordance with one or more embodiments of the present disclosure.

FIG. 3 is a functional diagram of a computing device for medium range speech communication in accordance with one or more embodiments of the present disclosure.

FIG. 4 is a method flow for medium range speech communication in accordance with one or more embodiments of the present disclosure.

### DETAILED DESCRIPTION

Embodiments of the present disclosure relate to systems, methods, and devices for providing medium range speech communication between portable devices. For example, one method includes receiving a query from a portable device within a medium range communication area of a medium range connection device; determining whether the query is in speech format; determining whether the query is a computing device readable text format; determining an action to take with the computing device and taking the determined action that produces a result of the query; and returning the result of the action to the portable device from which the query was received. Particularly helpful in embodiments of the present disclosure are embodiments utilizing HaLow Wi-Fi (also referred to as 802.11ah).

Wi-Fi HaLow is unique in that it uses low power connectivity making it usable in small portable devices. Its range is also longer than many other Internet of Things (IoT) technology options with less infrastructure needed. It also provides a more robust connection in challenging environments because of its unique ability to penetrate walls or other barriers within a building or facility.

Wi-Fi HaLow uses a sub-gigahertz (S1G) wireless radio operating in a frequency range between 750 MHz and 1 GHz. Its coverage distance is one mile from its source device (e.g., HaLow network access point).

The use of a HaLow network can provide communication coverage to a large facility without the substantial infrastructure of a cellular network (e.g., towers and transmitters) and has capabilities that allow for the functions discussed herein that cannot be provided by a typical Wi-Fi network, particularly at facilities where the Wi-Fi signal needs to travel between buildings (e.g., through the exterior and/or interior walls of multiple buildings).

Traditional Wi-Fi solutions have a range of only about 75 feet from its source and mediocre wall penetration. This means that considerably more traditional Wi-Fi network devices are needed to provide coverage wirelessly to the same area if it is possible at all.

HaLow Wi-Fi can also operate at a much lower power consumption than traditional Wi-Fi devices. For example, a coin battery powered device can operate for months or years. Many devices have a power consumption below 10 microwatts. HaLow Wi-Fi has unique algorithms to provide longer sleep times between beacon responses (check-ins with other network devices), which results in much longer device battery life. Additionally, HaLow Wi-Fi has power saving capabilities to allow for ultra-low power consumption that traditional Wi-Fi devices cannot achieve.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

As used herein, “a”, “an”, or “a number of” something can refer to one or more such things, while “a plurality of” something can refer to more than one such things. For example, “a number of buildings” can refer to one or more buildings, while “a plurality of buildings” can refer to more than one building.

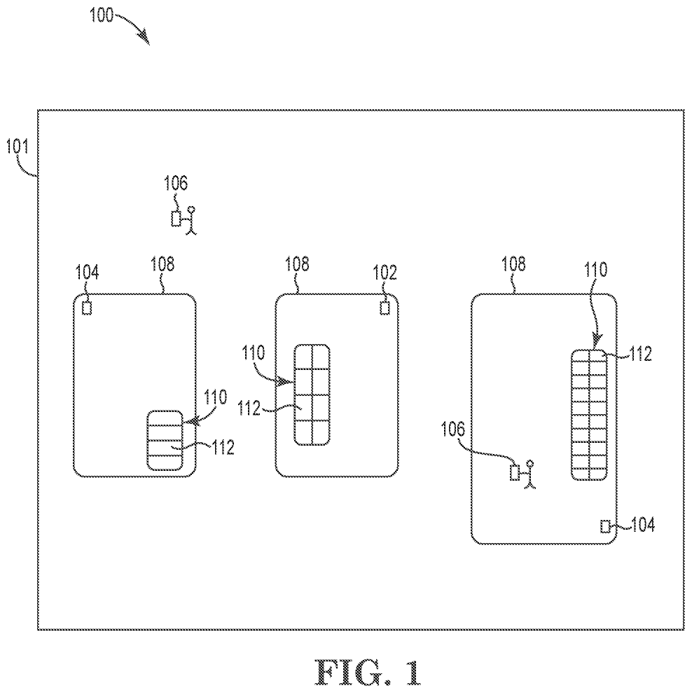

FIG. 1 is a medium range speech communication system at a facility in accordance with one or more embodiments of the present disclosure. As used herein, medium range communication is between 350 feet and 1½ miles.

In the embodiment of FIG. 1, a medium range communication system 100 is shown having a facility 101 with a number of buildings 108 therein. Within the buildings (roofs removed for easy viewing) 108 are shelving units 110 each with different types of products 112 thereon. These different types of products are represented by different sized and shaped blocks but these are not the only distinguishing characteristics, as will be discussed below.

The system 100 includes communication devices 104 and a system control computing device 102. In some embodiments, the system control computing device can also include communication device functionalities, thereby allowing it to serve a dual purpose. The communication devices illustrated are 802.11ah devices thereby allowing for long range (a range of 1 mile is illustrated between each of the devices 104 from its adjacent device(s). The 802.11ah devices also can penetrate at least one of the walls of the buildings 108.

In the illustrated embodiment, the device's signal can penetrate two building walls which allows the left and right devices to communicate with the center device which can allow information to be communicated between the left and right devices. In some embodiments where the left and right devices are within communication range of each other, they can be designed to penetrate the four walls between them and any other obstacles, such as shelving and products, in the signal transmission path between two communication devices.

Also illustrated in FIG. 1 are two people that have portable devices 106. As discussed herein, one person may want to locate the other person or to contact the other person to initiate a voice call with them. In some embodiments a person, via their device 106, may want to request a query about a product 112 at the facility 101. The devices 106 can be referred to as audio user devices as used herein. These processes will be discussed in more detail below.

Provided below is an example embodiment of a medium range speech communication system. In this example, the communication system is an 802.11ah medium range network having a number of human interface devices (e.g., portable devices capable of audio communication via a Wi-Fi network, such as walkie talkies, mobile phones, etc.) and a number of computing devices (e.g., computer servers) communicating through a number of 802.11ah network nodes (e.g., access points) interspersed within a facility.

At least one of the human interface devices being a first audio user interface device that receives voice instructions from a user that includes an instruction for a first one of the number of computing devices, creates a voice instruction data file (a speech format query), and communicates the voice instruction data file via one of the 802.11ah nodes to the first computing device. The first computing device having a processor and memory with instructions stored in the memory.

The instructions being executable on the processor to: receive the voice instruction data file; translate the voice instruction data file to a text instruction data file (text format query); search a database (e.g., in data store 361) for an appropriate response to the instruction. Once an appropriate response is determined, create a text response data file; translate the text response data file to a voice response data file; and communicate the voice response data file via one of the 802.11ah network nodes from the first computing device.

The first audio user device having a processor and memory with instructions stored in the memory. The instructions are executable on the processor to: receive the voice response data file and play the voice response data file to the user via a speaker on the first audio user device.

Through the above example embodiment, a user can present a query by speaking into a microphone on their portable device and receive an audio response from the system via a speaker on the device. Such as system can provide substantial benefits, such as being much quicker than typing the query, less distracting for the user, and substantially hands free.

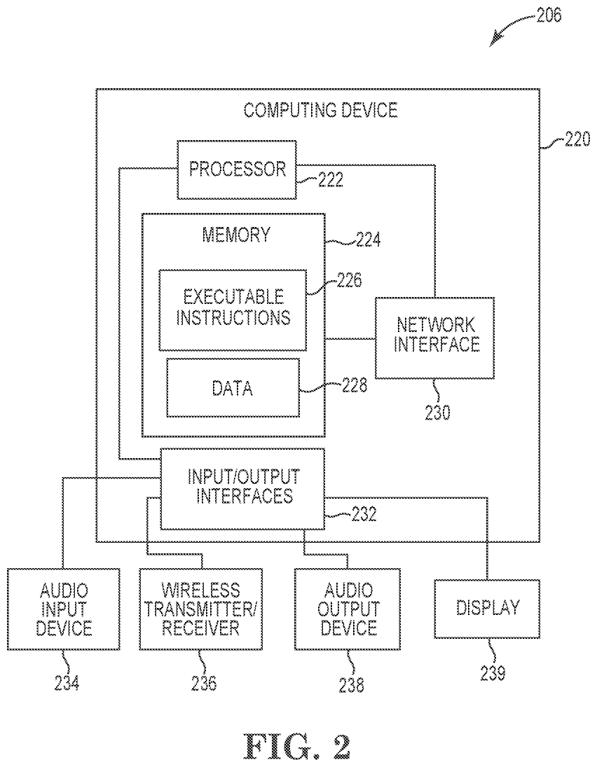

FIG. 2 is a computing device for medium range speech communication in accordance with one or more embodiments of the present disclosure. A computing device 220 as illustrated in FIG. 2 can, for example, be utilized as a portable device by a user for the medium range communication system, such as that shown in FIG. 1 at 106.

In the embodiment of FIG. 2, the apparatus 206 includes a computing device 220, an audio input 234, a wireless transmitter/receiver 236, an audio output device 238, and a display 239. The computing device 220 includes a processor 222 that is used to execute executable instructions 226 stored in memory 224. The executable instructions can, for example, initiate a voice call, record an audio query (via the audio input device 234, such as a microphone) to create a speech format file send the speech format file to the system control device, receive a speech format file containing the results of the query, play the speech format file to the user (via the audio output device 238, such as a speaker), or conduct a voice call, among other functions.

The memory also includes data 228 that can be used during the above functions. For example, data can include speech format files, information about the user of this particular portable device, information about this particular portable device, among other useful data. Examples of such information include the name of the user, an identifier if the user has been assigned one, the user's portable device identifier, the user's portable device last location.

The computing device 220 also includes a network interface 230. The network interface 230 can, for example, be used to receive updated executable instructions and/or data and can be a part of the 802.11ah network or a different type of network.

The input/output interfaces 232 connect components 234, 236, 238, and 239. The audio input can receive audio files from portable devices that include queries to be handled. The transmitter/receiver 236 can assist in communicating audio files to and/or from the portable devices. The user input device can be a keyboard or mouse, for example. The display can be a visual screen that displays information to a user viewing the display.

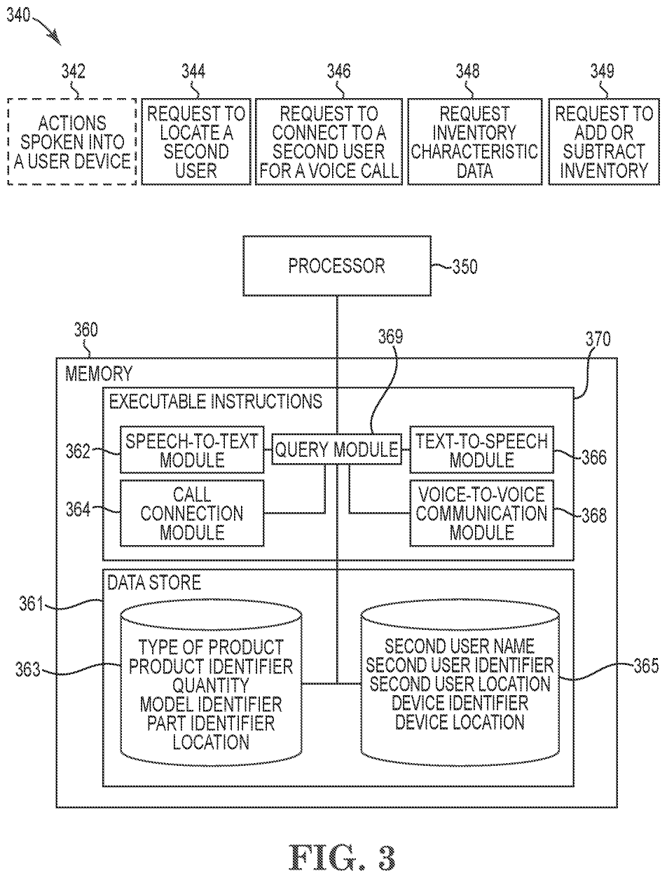

FIG. 3 is a functional diagram of a computing device for medium range speech communication in accordance with one or more embodiments of the present disclosure. At the top of FIG. 3, a number of actions 344, 346, 348, 349 to be taken by the system 340 are shown. To initiate a request for an action to be taken a user may make a query by speaking into their portable user device at 342. Each of these actions utilizes different elements stored in memory 360.

Memory 360 can be volatile or nonvolatile memory. Memory 360 can also be removable (e.g., portable) memory, or non-removable (e.g., internal) memory. For example, memory 360 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Within the memory 360, the executable instructions at 370 can, for example, determine whether a query is in a text or speech format, initiate a speech-to-text module or text-to-speech module, determine an action to take based on the content of the query, carry out the action, initiate a voice call connection, conduct a voice call, return the result of the action to the device from which the query was received, among other functions.

The memory also includes data store 361 that can be used during the above functions. For example, data can include speech format files, text format files, information about people with portable devices that are at the facility, information about portable devices that are at the facility, data about the characteristics of the products in inventory at the facility, among other useful data.

Further, memory 360 and processor 350 are located a computing device within the medium range speech communication system. In the illustrated system shown in FIG. 1, this computing device could be device 102. Although, illustrated as being located in computing device 102, embodiments of the present disclosure are not so limited. For example, memory 360 can also be located internal to another computing resource (e.g., enabling computer readable instructions to be downloaded over the Internet or another wired or wireless connection).

For example, for a request to locate a person 344 at the facility, the processor 350 uses the query module 369 to receive the query file and determine whether it needs conversion from speech-to-text and, if so, utilizes the speech-to-text module 362, executed by the processor, to do so. The data store 361 can have information about the location of people in the facility. For example, the data store can include the name of the person, an identifier if the person has been assigned one, the user's portable device identifier, the user's portable device last location.

If a call is to take place, a request query 346 is made by the user speaking into their portable device (e.g., 106 of FIG. 1). For example, the user could say “I'd like to speak with Jeff.” The system could process that query and say, “there are three Jeffs, did you mean Jeff Stier, Jeff Odens, or Jeff Cameron?” The user could then reply by saying “Jeff Stier”. Then, the call connection module 364 instructions can be executed by the processor 350. The call connection module 364 locates Jeff Stier's portable device and alerts Mr. Stier via his device that someone would like to have a call.

Once connected, the executable instructions 370 for providing voice-to-voice communication module 368 can be executed and the call can be conducted. The query module 269 can also be used to convert query results from text-to-speech via the text-to-speech module 366.

In some embodiments, the voice response data file that is returned to the portable device (first audio user device) making the query can include a confirmation that a second audio user device is the correct device for establishing a voice communication session. This can, for example, be accomplished by including a name of a user of the second audio user device.

In various embodiments, the voice response data file includes a request that the user provide a voice or text confirmation that the name of the user is correct. This could simply be for the user to say “yes” to confirm.

In some embodiments, the system further includes a second audio user device and wherein the query is to locate the second audio user device on the 802.11ah network. In such an embodiment, the voice response data file can, for example, include a description of a location of the second audio user device within a facility. For instance, the system could return the result that the second audio user device is outside the southwest corner of Building B. This information could be derived by GPS tracking, signal strength triangulation based on the locations of access points of any other suitable location process available to the system.

The system 340 also allows for users to request queries regarding items that are tracked at the facility. For instance, a user can request inventory characteristic data at 348 via their user portable device.

The request can be handled by the query module 369 with assistance from the speech-to-text module 362 and the item information data 363 stored in the data storage area 361. Data, such as quantity inventory data can, for example, include a type of item, item identifier, item name, quantity of the item at the facility, item model identifier, part identifier, item location, a description of what the item is, a description of what the item does, a description of the location of the item within the facility, a set of item physical dimensions, an item weight, an item location history, among other useful information.

The result of the query can then be converted from text-to-speech by the text-to-speech module 366 and then sent back to the portable user device where the result can be played audibly by a speaker on the portable user device. For example, the user can speak into the portable user device and say, “how many flange parts are available?” The system can access the data as described above and the portable user device can say “there are 4 flange parts available.”

The user can, then follow-up and say, “where are they located?” and the system can audibly reply “there are two flanges located on shelf three on shelving unit #1 and two more located on shelf 5 of shelving unit #8. The closest location to you is unit #8. It is two rows to the right near the wall.”

Another example of how the system could be used is in the automobile industry. For instance, the items can be the number, make, model, year, and/or type (e.g., SUV, sedan, etc.) of automobiles on a lot, for sale, resale, maintenance, and/or new vehicle preparation, etc. The inventory characteristics could be equipment listed on the window sticker, a new or resold vehicle punch list with items needing to be done before handing the vehicle over to the buyer, maintenance items needing to be addressed by a repair technician, and/or location of the vehicle at the facility. Actions to be taken are providing such information to a user and/or updating such information.

In some embodiments, instead of a speech file, the system can send another type of media file (e.g., picture or video file) in response to a query. For example, the video file can provide updated information to the user. For instance, a video showing that a package being delivered to a loading dock or picture of proof that an action has taken place are two situations in which an image or video would be beneficial.

In various embodiments, the system can allow a request for a larger amount of information, such as the entire chain of custody for an item. This can be beneficial where a buyer wants to audit the path of an item. This could be helpful, for instance, where a user wants to identify who damaged the item in transit.

Another useful query is used to update an inventory of items. Here, a query is presented at 349 where the user speaks into their portable device by saying “I took one flange from shelving unit #8.” The system will answer the query by updating the inventory in the data store 363 and replying audibly via the user portable device “the system has updated the inventory.”

Inventory can also be added. For example, a query is presented at 349 where the user speaks into their portable device by saying “I placed three flanges on shelf #2 at shelving unit #12.” The system will answer the query by updating the inventory in the data store 363 and replying audibly via the user portable device “the system has updated the inventory.”

It should be noted that in all of the above examples, every spoken query is converted to text and every text reply is converted to speech. This allows for a fluid audible discussion with the system 340 that may be so fluid that the user does not know the other party to the communication is non-human.

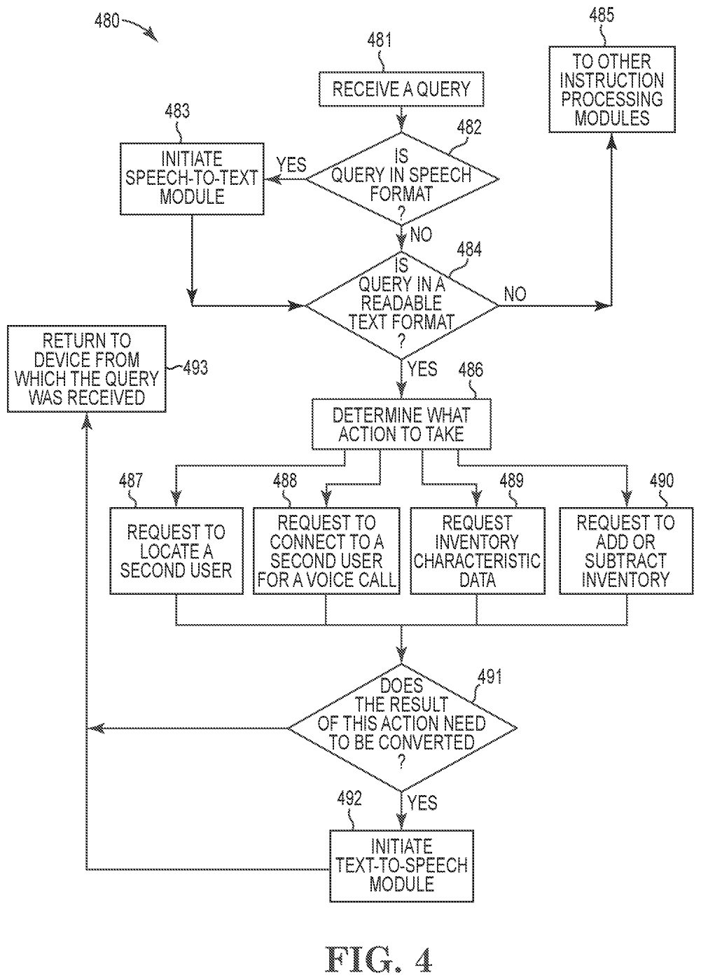

FIG. 4 is a method flow for medium range speech communication in accordance with one or more embodiments of the present disclosure. The flow 480 begins with receiving a query from a portable device within a medium range communication area of a medium range connection device at 481.

At 482, the flow determines whether the query is in speech format. If it is, then the executable instructions executed by the processor initiate speech-to-text conversion via the speech-to-text module, at 483. If the query is not in speech format, then the executable instructions execute to determine whether the query is a computing device readable text format, at 484. If the format is not speech and not readable text, then the query is diverted to other processing modules, if any are utilized to see if the query can be processed in another manner, at 485.

If the query is in computing device readable text format (either directly from the query itself or from conversion via the speech to text converter), then the processor reads the query and executes instructions to determine an action to take with the computing device based on the information provided in the text query, at 486.

The determined action that produces a result of the query is taken at 487, 488, 489, 490. The result of the action to the portable device from which the query was received, at 493. In some embodiments, executable instructs are executed to determine whether the result of the action needs to be converted, at 491. If it does need to be converted, then the text-to-speech module is initiated and the result is converted to a speech file or data, at 492.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A medium range speech communication system, comprising:
an 802.11ah medium range network having a number of human interface devices and a number of computing devices communicating through a number of 802.11ah network nodes interspersed within a facility;
at least one of the human interface devices being a first audio user interface device that receives voice instructions from a user that includes an instruction for a first one of the number of computing devices, creates a voice instruction data file, and communicates the voice instruction data file via one of the 802.11ah nodes to the first computing device,
the first computing device having a processor and memory with instructions stored in the memory that are executable on the processor to:
receive the voice instruction data file;
translate the voice instruction data file to a text instruction data file;
search a database for an appropriate response to the instruction;
create a text response data file;
translate the text response data file to a voice response data file; and
communicate the voice response data file via one of the 802.11ah network nodes from the first computing device; and
the first audio user device having a processor and memory with instructions stored in the memory that are executable on the processor to:
receive the voice response data file; and
play the voice response data file to the user via a speaker on the first audio user device.

2. The system of claim 1, wherein the system further includes a second audio user device and wherein the instruction is to locate the second audio user device on the 802.11ah network and connect the first and second audio user devices for voice communication between the first and second audio user devices.

3. The system of claim 2, wherein the voice response data file includes a confirmation that the second audio user device is the correct device for voice communication.

4. The system of claim 3, wherein the confirmation that the second audio user device is the correct device for voice communication includes a name of a user of the second audio user device.

5. The system of claim 4, wherein the voice response data file includes a request that the user provide a voice or text confirmation that the name of the user is correct.

6. The system of claim 1, wherein the system further includes a second audio user device and wherein the instruction is to locate the second audio user device on the 802.11ah network and wherein the voice response data file includes a description of a location of the second audio user device within a facility.

7. A medium range speech communication system, comprising:
an 802.11ah medium range network having a number of human interface devices and a number of computing devices communicating through a number of 802.11ah network nodes interspersed within a facility;
at least one of the human interface devices being a first audio user interface device that receives voice instructions from a user that includes an instruction for a first one of the number of computing devices, creates a voice instruction data file, and communicates the voice instruction data file via one of the 802.11ah nodes to the first computing device,
the first computing device having a processor and memory with instructions stored in the memory that are executable on the processor to:
receive the voice instruction data file;
translate the voice instruction data file to a text instruction data file;
search a database for facility data about a facility that the user is located at;
create a text response data file including the facility data;
translate the text response data file to a voice response data file; and
communicate the voice response data file via one of the 802.11ah network nodes from the first computing device; and
the first audio user device having a processor and memory with instructions stored in the memory that are executable on the processor to:
receive the voice response data file; and
play the voice response data file to the user via a speaker on the first audio user device.

8. The system of claim 7, wherein the facility data is quantity inventory data indicating a quantity of items in inventory at the facility.

9. The system of claim 8, wherein the facility data is item location data indicating a location of an item in inventory at the facility.

10. The system of claim 9, wherein the voice response data file includes a description of the location of the item in inventory within the facility.

11. The system of claim 7, wherein the facility data is item description data that provides description information about an item in inventory at the facility.

12. The system of claim 11, wherein the quantity inventory data information is selected from the group including: an item name, a description of what the item is, a description of what the item does, a set of item physical dimensions, an item weight, an item location history.

13. A medium range speech communication system, comprising:
an 802.11ah medium range network having a number of human interface devices and a number of computing devices communicating through a number of 802.11ah network nodes interspersed within a facility;
at least one of the human interface devices being a first audio user interface device that receives voice instructions from a user that includes an instruction for a first one of the number of computing devices, creates a voice instruction data file, and communicates the voice instruction data file via one of the 802.11ah nodes to the first computing device,
the first computing device having a processor and memory with instructions stored in the memory that are executable on the processor to:
train a machine learning algorithm to search a database for an appropriate response to the instruction;
receive the voice instruction data file;
translate the voice instruction data file to a text instruction data file;
utilize the machine learning algorithm to search the database for the appropriate response to the instruction;
create a text response data file;
translate the text response data file to a voice response data file; and
communicate the voice response data file via one of the 802.11ah network nodes from the first computing device; and
the first audio user device having a processor and memory with instructions stored in the memory that are executable on the processor to:
receive the voice response data file; and
play the voice response data file to the user via a speaker on the first audio user device.

14. A method, comprising:
receiving a query from a portable device within a medium range communication area of a medium range connection device;
determining whether the query is in speech format;
determining whether the query is a computing device readable text format;
determining an action to take with the computing device and taking the determined action that produces a result of the query; and
returning the result of the action to the portable device from which the query was received.

15. The method of claim 14, wherein when the query is determined to be in a speech format, a speech-to-text module is initiated to convert the speech format query to a text format query.

16. The method of claim 14, wherein when the query is determined to be in a text format, a query module is initiated to determine the action to take.

17. The method of claim 14, wherein, if the result of the query is in a text format, initiating a text-to-speech module that converts the text format result of the query to a speech format result of the query.

18. The method of claim 14, wherein the determined action is requesting to locate someone within the facility.

19. The method of claim 14, wherein the determined action is requesting to connect with someone within the facility for a voice call.

20. The method of claim 14, wherein the determined action is requesting inventory characteristic data.

21. The method of claim 14, wherein the determined action is a request to add inventory.

22. The method of claim 14, wherein the determined action is a request to subtract inventory.

23. The method of claim 14, wherein the method further includes determining whether the result of the query needs to be converted before the query is returned to the portable device from which it was received.

24. A portable medium range communication device, comprising:
a processor and memory, the memory having instructions that are executable on the processor to:
receive a query from a portable device within a medium range communication area of a medium range connection device;
determine whether the query is in speech format;
determine whether the query is a computing device readable text format;
determine an action to take with the computing device and taking the determined action that produces a result of the query; and
return the result of the action to the portable device from which the query was received.
